(19) United States
(12) Patent Application Publication
(10) Pub. No.: US 2013/0287972 A1
(43) Pub. Date: Oct. 31, 2013

(54) HYBRID HEAT TRANSFER LABEL

(71) Applicant: ILLINOIS TOOL WORKS INC., Glenview, IL (US)

(72) Inventors: Joseph A. Tetrault, Stafford Springs, CT (US); James E. Moore, Manchester, CT (US)

(73) Assignee: ILLINOIS TOOL WORKS INC., Glenview, IL (US)

(21) Appl. No.: 13/756,936

(22) Filed: Feb. 1, 2013

Related U.S. Application Data
(60) Provisional application No. 61/639,301, filed on Apr. 27, 2012.

(51) Int. Cl. B41M 5/382

(52) U.S. Cl. CPC B41M 5/38214
USPC 428/32.6; 427/208.2

(57) ABSTRACT

Hybrid heat activated labels include a digitally printed graphic image layer, and protective layer and a heat activated adhesive layer, which are printed via a screen, flexographic, rotogravure, or pad printing method. The hybrid heat activated labels provide customized specialty labels quickly and easily through digitally printing the graphic image, while maintaining necessary adhesion and chemical/environmental resistance properties by utilizing ink and adhesive systems of screen, flexographic, rotogravure, and pad printing methods.

### BACKGROUND

The present disclosure generally relates to heat transfer labels, and more particularly to heat transfer labels including digitally printed markings and/or graphics.

Indicia and/or graphics-containing labels are in widespread use. For example, such labels are used in the garment industry to decorate clothing articles with graphic images or to mark them, for example, to identify the manufacture, size, washing instruction and the like. Other markets that use such labels include the durable goods market, for example, hand held power tools.

Heat transfer labels including graphics and/or markings are typically made using screen printing, flexographic printing or rotogravure priming processes, because ink and heat activated adhesive systems available for these printing processes can provide the necessary properties for heat transfer labels, such as adhesion to a target article, and chemical and/or other environmental resistance properties.

Digital printing is also known and can provide superior quality graphics with tight tolerances, fine details, and multi-color capabilities. Further, by using a digital printing method, labels can be personalized quickly and easily when compared to other conventional printing methods, since images can be printed from a digital based image, without the need for printing plates. However, ink and toner systems currently available for digital printing often do not have the characteristics necessary for heat transfer labels such as adhesion, and chemical and/or other environmental resistance.

Accordingly, there is a need for improved heat transfer labels, which can provide the advantages of digitally printed graphics and markings, and also maintain the durability advantages of adhesive and ink systems available for other printing methods.

### BRIEF SUMMARY

Hybrid heat transfer labels made using a combination of digital printing and at least one other conventional printing method, such as screen printing, are provided according to various embodiments. The hybrid heat transfer labels include a heat activated adhesive layer and a protective layer, which are printed via screen, flexographic, rotogravure, or pad printing method to provide excellent adhesion to a target article and good chemical and other environmental resistance. Further, the hybrid heat transfer labels include a digitally printed layer offering superior quality graphic images and markings that can be customized quickly and easily to provide cost effective specialty heat transfer labels.

In one aspect, a two-part hybrid heat transfer label is provided. A first part includes an adhesive layer arranged on a first carrier layer. A second pan includes a graphic layer and a protective layer, which are arranged on a second carrier layer. The first pan is applied on a substrate, and the second part is applied on top of the first part to form the hybrid heat transfer label.

In one embodiment, the graphic layer is digitally printed, and the adhesive layer and the protective layer are printed via a screen, flexographic, rotogravure, or pad printing method.

The first part can also include a tie layer and a first white backer layer. In such an embodiment, the first part has a three-layer configuration including the tie layer/the first white backer layer/the adhesive layer on the first carrier layer with the tie layer being adjacent the first carrier layer. The second part is configured such that the protective layer is arranged between the second carrier layer and the graphic image layer. Further, the second pan can also include a second white backer layer. In such an embodiment, the graphic image layer is arranged between the second white backer layer and the protective layer.

In one embodiment, the hybrid heat transfer label formed by heat transferring the first part on a substrate and the second pan on top of the first part has a five-layer configuration including adhesive layer/white backer layer/tie layer/graphic image layer/protective layer with the adhesive layer being attached to the substrate. The adhesive layer is formed from a heat activated adhesive configured to form a permanent bond with the substrate when subjected to heat and pressure. The tie layer is configured to soften and attach the second part to the first part when subjected to heat and pressure.

In another aspect, a method of making a hybrid heat transfer label is provided. The method includes steps of applying an adhesive layer, applying a protective layer, and providing a digitally printed graphic image layer between the adhesive layer and the protective layer. The adhesive layer and the protective layer are applied using a screen, flexographic, rotogravure, or pad printing method.

In one embodiment, the step of applying the adhesive layer includes screen printing a heat activated adhesive on a first release coated carrier, and applying a protective layer includes screen printing the protective layer on as second release coated carrier. The step of providing a digitally printed graphic image layer includes digitally printing the graphic image layer on top of the protective layer on the second release coated carrier. The adhesive layer is transferred onto a substrate by applying heat and pressure on the first release coated carrier, and the graphic image layer and the protective layer is applied over the adhesive layer by applying heat and pressure on the second release coated carrier, thereby arranging the digitally printed graphic image Layer between the adhesive layer and the protective layer.

In another embodiment, the step of applying the adhesive layer includes screen printing a tie layer on a first release coated carrier, screen printing a white backer layer on top of the tie layer, and screen printing a heat activated adhesive on top of the white backer layer. The step of applying a protective layer includes screen printing the protective layer on a second release coated carrier. Further, the step of providing a digitally printed graphic image layer includes digitally printing the graphic image layer on top of the protective layer on the second release coated carrier. The first release coated carrier including the tie layer, the white backer layer, and the adhesive layer is placed on a substrate with the adhesive layer facing the substrate. When subjected to heat and pressure the adhesive layer softens and adheres permanently to the substrate, and the first release coated carrier is peeled off from the tie layer leaving the tie layer, the white backer layer, and the adhesive layer attached to the substrate. Subsequently, the second release coated carrier including the graphic image layer and the protective layer is placed on top of the tie layer such that the graphic image layer faces the tie layer. When subjected to heat and pressure, the tie layer softens and permanently bonds with the graphic image layer, thereby arranging the digitally printed graphic image layer between the adhesive layer and the protective layer. When a greater opaqueness is desired, a second white backer layer can be digitally printed on top of the graphic image layer, such that the tie layer bonds with the white backer layer when subjected to heat and pressure.

In yet another embodiment, the step of applying a protective layer includes screen printing a protective layer on a release coated carrier, and providing a digitally pruned graphic image includes digitally printing a graphic image layer on top of the protective layer. Further, the step of applying an adhesive layer includes screen printing a heat activated adhesive over the digitally printed graphic image layer. The method can also include screen printing a white backer layer on top oldie digitally printed graphic image layer to provide a hybrid heat transfer label having a four-layer configuration including the protective layer/graphic image layer/white backer layer/adhesive layer on the release coated carrier with the protective layer being adjacent the release coated carrier.

In yet another aspect, a hybrid heat transfer label including a protective layer, a graphic layer, and an adhesive layer is provided, in which the graphic layer is digitally printed and arranged between the protective layer and the adhesive layer. The protective layer and the graphic layer are printed via a screen, flexographic, rotogravure, or pad printing method.

In one embodiment, the protective layer is a clear lacquer layer screen printed on a carrier, and the graphic layer is digitally printed on top of the protective layer. The adhesive layer is a heat activated adhesive screen printed on top of the graphic layer to provide a hybrid heat transfer label having a three-layer configuration including the protective layer/the graphic layer/the adhesive layer on the carrier with the protective layer being adjacent the carrier.

In another embodiment, the hybrid heat transfer label also includes a white backer layer digitally printed or screen printed on top of the graphic layer to provide a hybrid heat transfer label having a four-layer configuration including protective layer/graphic layer/white backer layer/adhesive layer on the carrier with the protective layer being adjacent the carrier.

Other aspects, objectives and advantages will become more apparent from the following detailed description when taken in conjunction with the accompanying drawings.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1 is a schematic cross sectional view of a first part of a two-part hybrid heat activated label according to an embodiment;

FIG. 2 is a schematic cross sectional view of the first part of FIG. 1 placed on a substrate;

FIG. 3 is a schematic cross sectional view of the first part of FIG. 1 heat transferred onto a substrate;

FIG. 4 is a schematic cross sectional view a second pan of a two-part hybrid heat activated label according to an embodiment;

FIG. 5 is a schematic cross sectional view of the second part of FIG. 4 placed on top of the first part of the label of FIG. 3;

FIG. 6 is a schematic cross sectional view of the two-part hybrid heat activated label on a substrate including the first part of FIG. 1 and the second part of FIG. 4;

FIG. 7 is a schematic cross sectional view of a first part of a two-part hybrid heat transfer label according to another embodiment;

FIG. 8 is a schematic cross sectional view of a second part of a two-part hybrid heat transfer label according to an embodiment; and

FIG. 9 is a schematic cross sectional view of a hybrid heat transfer label according to yet another embodiment.

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated. The words “a” or “an” are to be taken to include both the singular and the plural. Conversely, any reference to plural items shall, where appropriate, include the singular.

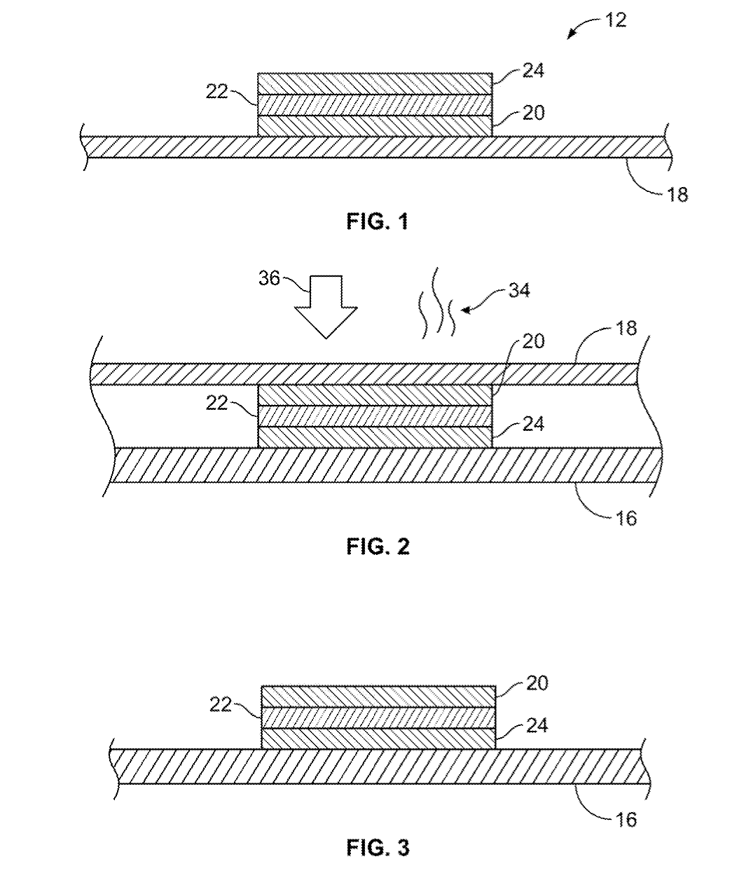

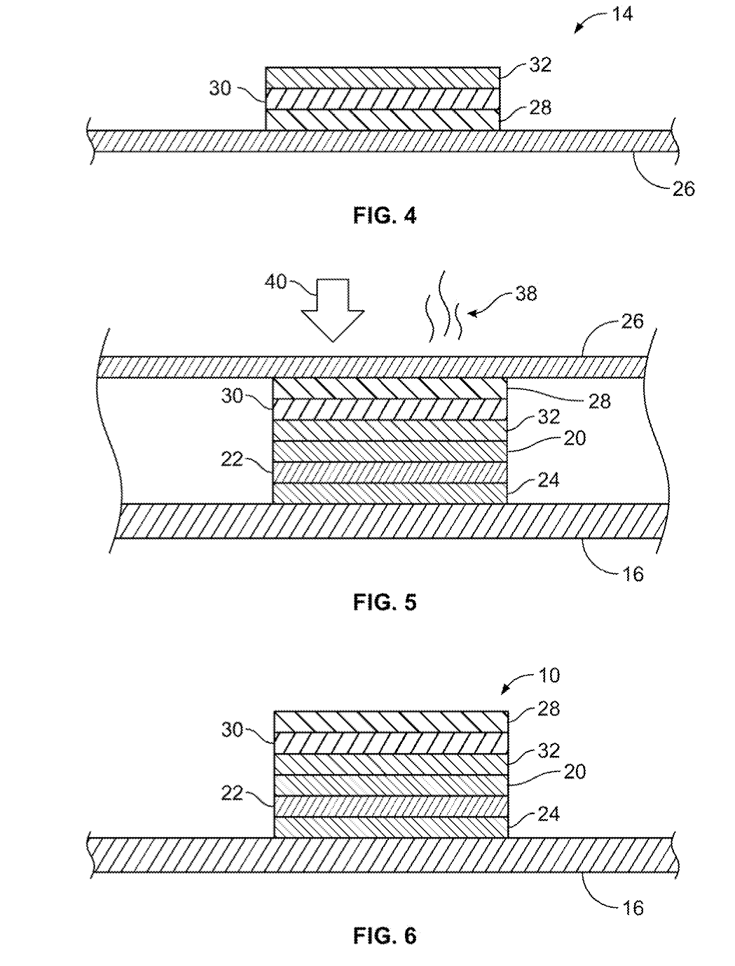

Referring to figures, FIGS. 1-6 illustrate a hybrid heat transfer label 10 including two parts 12, 14, and steps for applying the parts 12, 14 on a substrate 16 to form the hybrid heat transfer label 10 according to an embodiment. A “hybrid heat transfer label” used as herein refers to a heat transfer label made using a combination of digital printing and at least one other printing method, such as screen printing, flexographic printing, rotogravure printing, or pad printing. A schematic cross sectional view of a first part 12 of the hybrid heat transfer label 10 is shown in FIG. 1. The first part 12 generally includes a carrier layer 18, a tie layer 20. an optional white backer layer 22, and an adhesive layer 24. A schematic cross sectional view of a second part 14 is shown in FIG. 4. The second part 14 generally includes a carrier layer 26, a protective top layer 28, a graphic image layer 30, and an optional white backer layer 32. As shown in FIGS. 2, 3, and 5, the first part 12 is applied on the substrate 16, and subsequently, the second part 14 is applied on top of the first part 12, thereby forming the hybrid heat transfer label 10. A schematic cross sectional view of the hybrid heat transfer label 10 on the substrate 16 is shown in FIG. 6. The hybrid heat transfer label 10 generally includes the adhesive layer 24, the optional white hacker layer 22, the tie layer 20, the optional white backer layer 32, the graphic image layer 30, and the protective top layer 28.

In one embodiment, each of the layers 20, 22, 24 of the first part 12 is screen printed on the carrier layer 18. The carrier layer 18 can be formed from a paper or plastic film. Suitable materials for the carrier layer 18 include polypropylene film, as well as polyester films, with polyester being more heat resistant. MYLAr® and MELINEX® are two trademarks under which these materials are commercially available. Paper is less costly than plastic films, however, the dimensional stability of paper is less desirable unless printing is conducted in a controlled environment with regard to temperature and relative humidity. Preferably, the carrier layer 18 is a release coated paper or plastic film. The release coating can be silicone based, or it can employ other coatings that will be recognized by those skilled in the art. In some embodiments, both sides of the carrier layer 18 are coated with release coatings, in which the release coatings have different release characteristics. For example, the printed side will generally have a tighter release than the non-printed side.

In making the first part 12, the tie layer 20 is screen printed on the carrier layer 18 in the first printing pass. The tie layer 20 is configured to attach the second part 14 on the first part 12 when subjected to heat 38 and pressure 40 as shown in FIG. 5. The tie layer 20 is formed from a polymeric material that softens and bonds with the top layer of the second part 14 when subjected to heat 38 and pressure 40 during the heat transfer process. Thus, in the embodiment shown in FIGS. 1-6, the material for the tie layer 20 is selected such that the tie layer 20 permanently adheres to the optional white backer layer 32 of the second part 14 when sufficient heat 38 and pressure 40 are applied during the heat transfer process. In another embodiment, the second part 14 may not include the optional white backer layer 32, and thus, the material for the tie layer 20 is selected such that the tie layer 20 permanently adheres to the graphic image layer 30 when subjected to the heat and pressure. Preferably, the tie layer 20 is formed by screen printing a layer of a clear lacquer on the carrier layer 18.

The optional white backer layer 22 is screen printed on top of the tie layer 20 on the carrier layer 18. The optional white backer layer 22 can be printed using various known ink systems including a white pigment. In one embodiment, the optional white backer layer 22 is formed of a white ink formulation including a resin solution (formulated from 36.73 percent by weight ethyl 3-ethoxypropionate, 4.51 percent by weight cyclohexanone, 4.61 percent by weight Estane® 5703 thermoplastic polyurethane resin and 1.14 percent by weight CAB-381-20 cellulose ester resin), 1.84 percent by weight Nanomer® 1.28E nanoclay, white paste (formulated from 18.66 percent by weight ethyl 3-ethoxypropionate, 3.96 percent by weight cyclohexanone, 5.66 percent by weight Estane® 5703, and 18.86 percent by weight TIOXIDE® TR90 titanium dioxide), 0.86 percent by weight INEOS® IJI silica gel, 0.17 percent by weight TEGO® Foamex N defoamer and 3.00 percent Desmodur® N-75 aliphatic polyisocyanate. The white ink can be screen printed through a stainless steel mesh, for example, with 270 lines per inch, on top of the tie layer 20. The white ink can be applied once or multiple passes.

The adhesive layer 24 is screen printed on top of the optional white backer layer 22. The adhesive layer 24 can be formed from a suitable heat activated adhesive, which softens and forms a permanent band with the substrate 16 when subjected to heat 34 and pressure 36 as shown in FIG. 2. A heat activated adhesive can he screen printed once or multiple passes depending on a desired thickness of the adhesive layer 24. The first part 12 is configured such that the adhesion between the tie layer 20 and the optional white backer layer 22, and the adhesion between the white backer layer 22 and the adhesive layer 24, and the adhesion between the adhesive layer and the substrate 16 when subjected to heat 34 and pressure 36 are greater than the adhesion between the carrier layer 18 and the tie layer 20, such that the layers 20, 22, 24 remain attached and transfer together onto the substrate 16 during the heat transfer process as shown in FIG. 3.

In one embodiment, a heat activated adhesive for the adhesive layer 14 includes one or more powdered resins including polyamide, polyester, and polyurethane. Suitable polyamide resins include GRILTEX® IA and other polyamides from EMS-GRILTECH, a unit of EMS-CHEMIE, as well as UNEX®PA T11 and other polyamides from DAKOTA COATINGS N.V. Suitable polyester resins include GRILTEX® 6E and other polyesters from EMS-GRILTECH and UNEX®PES T6 and other polyesters from DAKOTA COATING N.V. Suitable polyurethane resins include UNEX® 4529 and other polyurethanes from DAKOTA COATINGS N.V. It will be appreciated that the examples given of suitable compositions are for explanatory purposes and is not an exhaustive list and should not be taken to limit the present disclosure. The adhesive powder resin can be dispersed in a resin solution, solvent, or water prior to printing.

Although the layers 20, 22, 24 of the first part 12 are screen printed on the carrier layer 18 in this embodiment, other printing methods, such as flexo, gravure, or pad printing, can be utilized to apply the layers 20, 22, 24 in other embodiments. However, gravure printing generally requires long runs due to the high cost of cylinders. Further, screen printing can provide thicker ink deposits when compared to flex and gravure printing methods. An alternative method of applying the adhesive layer 24 is to spread the dry adhesive powder resin over the wet ink layer 22. Spreading the adhesive powder over the wet ink layer 22 can avoid the appearance of a halo and minimizes the total number of print stations.

The second part 14 is made using a combination of screen printing and digital printing methods. The protective top layer 28 is screen printed first on the carrier layer 26. Preferably, the protective top layer 28 is a clear coat of a lacquer material to provide a chemically and environmentally resistant outer layer to the hybrid heat transfer label 10 after it is applied to the substrate 16. The carrier layer 26 is the same or similar to the carrier layer 18, preferably a release coated paper or film.

In one embodiment, the protective top layer 28 is printed from a composition comprising about 82.6% by weight Estane®5703 resin solution (comprised of about 20% polyester type thermoplastic polyurethane in a cyclohexanone/ethyl 3-ethoxypropionate mixture) (Lubrizol Advanced materials, Inc.), about 9.9% CAB-381-20 resin solution (comprised of about 20% cellulose acetate butyrate in a cyclohexanone/ethyl 3-ethoxypropionate mixture) (Eastman Chemical Company), about 5% cyclohexanone (Ashland Inc.), about 2% Cab-O-Sil® TS-610 fumed silica (Cabot Corp), and about 0.5% TEGO® Foamex-N defoamer (Evonik industries AG). The above composition contains about 20.5%, by weight, solids and about 79.5%, by weight, VOCs. Optionally, the protective top clear can contain any of several crosslinking agents to improve the toughness and chemical resistance of the protective top clear, e.g. 5% of Desmodur® N-75 aliphatic polyisocyanate (Bayer Material Science).

To form the protective to layer 28, the above described composition can be screen printed on the carrier layer 18. Alternatively, the composition can be deposited via gravure, flexo, or pad printing methods.

The graphic image layer 30 is digitally printed an top of the protective top layer 28. The graphic image layer 30 may be a continuous layer covering substantially the entire top surface of the protective top layer 28, or can be printed to cover only a portion or portions of the protective top layer 28. The graphic image layer 30 can include various digitally based graphic images and/or markings, which can be printed, without a printing plate. Thus, it allows for on demand printing, variable data printing, and modifications of an image with each impression. For example, a personalized image or markings can be printed via a laser or inkjet printer on the protective layer 28 to form the graphic image layer 30. An ink or toner system is selected such that the graphic image layer 30 permanently adheres to the protective layer 28. Although, ink or toner systems for the digital printing do not typically provide chemical or environment resistance necessary for heat transfer labels, the hybrid heat transfer label 10 is configured such that the graphic image layer 30 is protected under the protective top layer 2$ to provide desired properties.

The optional white backer layer 32 can be digitally printed on top of the graphic image layer 30, if necessary to complete a desired graphic image or markings.

Although the layers 20, 22, 24, 28, 30, 32 of the first part 12 and the second part 14 of this embodiment are provided by a combination digital printing and screen printing, in other embodiments, another printing method can be combined with digital printing, or two or more different printing methods can be combined with digital printing to make the first and second parts 12, 14. For example, some layers, such as the protective top layer 28, can be pad printed, while other layers, such as the adhesive layer 24, can be screen printed and the graphic layer 30 is digitally printed. Further, graphics of the hybrid heat transfer label 10 can be provided by a combination of digital printing and another printing method. For example, a portion of the graphics can he screen printed, while other portions are digitally printed. In an embodiment, a logo that is commonly included in every label for a particular customer is screen printed, while various design portions are digitally printed. The screen printed graphic portion can be a layer on the first part 12 or a layer on the second part 14. For example, the optional white baker layer 32 can be replaced with a screen printed graphic layer in some embodiments.

In one embodiment, the hybrid heat transfer label 10 is applied on a fabric, for example a shirt. To assemble the hybrid heat transfer label 10 on the fabric 16, the first part 12 is applied on the fabric 16 with the adhesive layer 24 facing the fabric 16 as shown in FIG. 2. The layers 20, 22, 24 of the first part 12 are transferred onto the fabric 16 when heat 34 and pressure 36 are applied on the carrier layer 18 with a heat press machine such as the Model 718 heat press machine available from Insta Graphic Systems, Cerritos, Calif. The silicone pad temperature is about 335° F., and about 22 psi of pressure is applied for a duration of about 10 seconds.

When heat 34 and pressure 36 are applied, the adhesive layer 24 softens and adheres to the fabric 16 permanently. Since the adhesion strengths between the layers 20, 22, 24 are greater than that of the tie layer 20 and the carrier layer 18, the layers 20, 22, 24 remain attached and transfer together to the fabric 16 upon application of heat 34 and pressure 36 as shown in FIGS. 2 and 3. After the heat transfer process, the carrier layer 18 is peeled off from the tie layer 20, and the layers 20, 22, 24 are permanently attached on the fabric 16 via the adhesive layer 24 with the tie layer 20 arranged on the top as shown in FIG. 3.

Subsequently, the second part 14 is placed on top of the tie layer 20, such that the optional white backer layer 32 and the tie layer 20 face each other as shown in FIG. 5. Heat 38 and pressure 40 are applied on the carrier layer 26 side of the second part 14 using a suitable method, such as a heat press machine as described above. When subjected to heat 38 and pressure 40, the tie layer 20 softens and forms a permanent bond with the optional white backer layer 32. The hybrid heat transfer label 10 is configured such that the adhesion strength between the adhesive layer 24 and the fabric 16 and the adhesion strengths between the layer 24, 22, 20, 32, 30, 28 are greater than that of between the protective layer 28 and the carrier layer, such that when the carrier layer 26 is peeled off from the protective to layer 28 after the heat transfer process, the layers 24, 22, 20, 32, 30, 28 remain attached together on the fabric 16 as shown in FIG. 6.

The hybrid heat transfer label 10 is configured such that the digitally printed layers 30, 32 are sandwiched between the screen printed layers 28, 20, 22 24 to provide desired adhesion and chemical/environmental resistance properties. Further, the heat transfer label 10 having two parts 12, 14 can improve flexibility for specialty short run labels and minimize inventory, since the graphic image layer 32 and other digitally printed layers 32 can be customized and printed at the point of beat transfer.

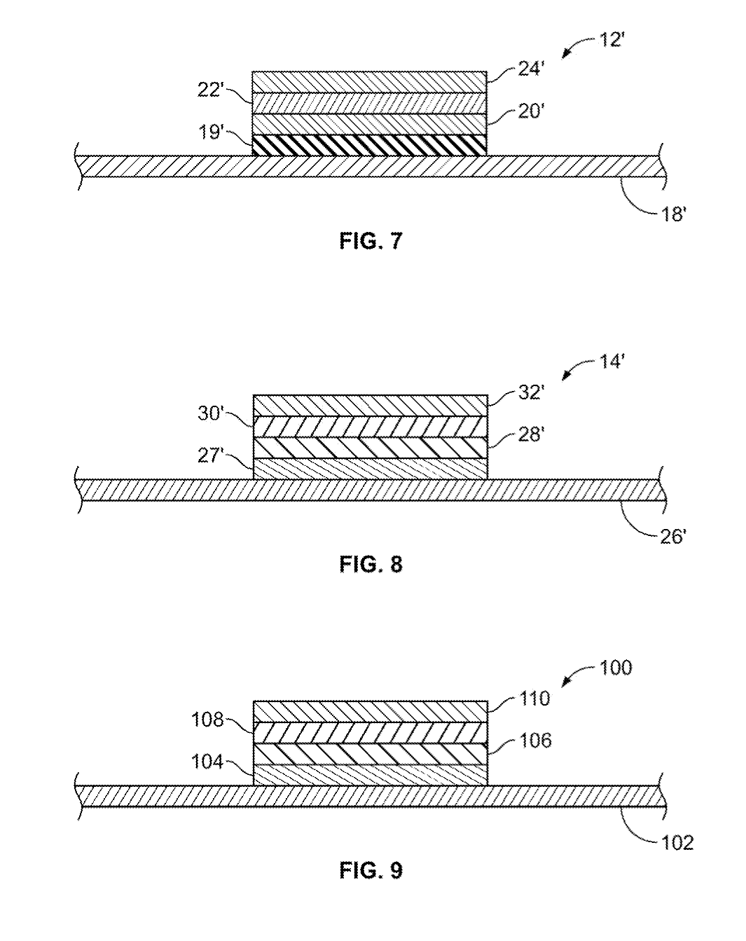

FIG. 7 illustrates a first part 12′ according to another embodiment. The first part 12′ is similarly configured as the first part 12 including a tie layer 20′, an optional white backer layer 22′, an adhesive layer 24′, except a carrier layer 18′ is uncoated film. Thus, a release layer 19′ is screen printed on the carrier layer 18′, on top of which the tie layer 18′, the optional backer layer 22′ and the adhesive layer 24′ are subsequently printed. When subjected to heat and pressure, the layers 20′, 22′, 24′ transfer together onto a substrate and the release layer 19′ remains on the carrier layer 18′.

FIG. 8 illustrates a second part 12′ according to another embodiment. The second part 12′ is similarly configured as the second part 12 including a protective top layer 28′, a graphic image layer 30′, and an optional white hacker layer 32′, except a carrier layer 26′ is uncoated film. Thus, a release layer 27′ is screen printed on the carrier layer 26′, on top of which the protective top layer 28′, the graphic image layer 30′ and the optional white backer layer 32′are subsequently printed. When subjected to heat and pressure, the layers 28′, 30′, 32′ transfer together onto a tie layer of a first part and the release layer 27′ remains on the carrier layer 26′.

FIG. 9 illustrates a hybrid heat transfer label 100 according to one embodiment. As it was with the hybrid heat transfer label 10, the hybrid heat transfer label 100 is made using hybrid printing methods including digital printing and at least one other printing method, such as screen printing. The hybrid heat transfer label 100 includes similar layers as the hybrid heat transfer label 10, and thus, only distinguishable features of the hybrid heat transfer label 100 are highlighted below.

The hybrid heat transfer label 100 includes a protective layer 104, a graphic image layer 106, an optional white backer layer 108, and an adhesive layer 110, except these layers 104, 106, 108, 110 are arranged on one release coated carrier 102, unlike the two-part system of the hybrid heat transfer label 10. in preparing the hybrid heat transfer label 100, the protective layer 104 is screen printed on the release coated carrier 102. Subsequently, the graphic image layer 106 is digitally printed on top of the protective layer 104. Then, the optional white backer layer 108 is screen printed on top of the graphic image layer 106 to provide desired opaqueness. Finally, the adhesive layer 110 is screen printed on top of the optional white backer layer 108. When subjected to heat and pressure, the adhesive layer 110 softens and adheres to a substrate, and the layers 104, 106, 108 transfer onto the substrate with the adhesive layer 110.

From the foregoing it will he observed that numerous modifications and variations can he effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A hybrid heat transfer label, comprising;
a first part including an adhesive layer, the adhesive layer arranged on a first carrier layer: and
a second part including a graphic layer and a protective layer, the graphic layer and the protective layer arranged on a second carrier layer,
wherein the first part is applied on a substrate, and the second part is applied on top of the first part to form the hybrid heat transfer label.

2. The hybrid heat transfer label of claim 1, wherein the graphic layer is digitally printed, and the adhesive layer and the protective layer are printed via a screen, flexographic, rotogravure, or pad printing method.

3. The hybrid heat transfer label of claim 1, wherein the first part further includes a tie layer and a first white backer layer, wherein the first part has a three layer configuration including the tie layer/the first white backer layer/the adhesive layer on the first carrier layer with the tie layer being adjacent the first carrier layer.

4. The hybrid heat transfer label of claim 1, wherein the second part is configured such that the protective layer is arranged between the second carrier layer and the graphic image layer.

5. The hybrid heat transfer label of claim 4, wherein the second pan further includes a second white backer layer, wherein the graphic, image layer is arranged between the second white backer layer and the protective layer.

6. The hybrid heat transfer label of claim 4, wherein the hybrid heat transfer label is formed by heat transferring the first part on a substrate, and the second part, on top of the first part, has a five-layer configuration including the adhesive layer/the first white backer layer/the tie layer/the graphic image layer/the protective layer with the adhesive layer being on the substrate.

7. The hybrid heat transfer label of claim 1, wherein the adhesive layer is a heat activated adhesive configured to form a permanent bond with the substrate when subjected to heat and pressure.

8. The hybrid heat transfer label of claim 1, wherein the tie layer is configured to soften and attach the second part to the first part when subjected to heat and pressure.

9. A method of making a hybrid heat transfer label, comprising steps of:
applying an adhesive layer;
applying as protective layer; and
providing a digitally printed graphic image layer between the adhesive layer and the protective layer;
wherein the adhesive layer and the protective layer are applied using a screen, flexographic, rotogravure, or pad printing method.

10. The method of claim 9, wherein applying the adhesive layer includes screen printing a heat activated adhesive on a first release coated carrier, applying the protective layer includes screen printing the protective layer on a second release coated carrier, and providing a digitally printed graphic image layer includes digitally printing the graphic image layer on top of the protective layer on the second release coated carrier, wherein the adhesive layer is transferred onto a substrate by applying heat and pressure on the first release coated carrier, and the graphic image layer and the protective layer are applied over the adhesive layer by applying heat and pressure on the second release coated carrier, thereby arranging the digitally printed graphic image layer between the adhesive layer and the protective layer.

11. The method of claim 9, wherein applying the adhesive layer includes screen printing a tie layer on a first release coated carrier, screen printing a white backer layer on top of the tie layer, and screen printing as heat activated adhesive on top of the white backer layer, wherein applying the protective layer includes screen printing the protective layer on a second release coated carrier, and providing the digitally printed graphic image layer includes digitally printing the graphic image layer on top of the protective layer on the second release coated carrier; wherein the first release coated carrier including the tie layer, the white backer layer, and the adhesive layer is placed on a substrate with the adhesive layer facing the substrate, wherein the adhesive layer softens and adheres permanently to the substrate when subjected to heat and pressure, wherein the first release coated carrier is peeled of from the tie layer leaving the tie layer, the white backer layer, and the adhesive layer attached to the substrate, wherein the second release coated carrier including the graphic image layer and the protective layer is placed an top of the tie layer such that the graphic image layer faces the tie layer, and wherein the tie layer softens and permanently bonds with the graphic image layer when subjected to heat and pressure, thereby arranging the digitally printed graphic image layer between the adhesive layer and the protective layer.

12. The method of claim 11, wherein a second white backer layer is digitally printed on top of the graphic image layer, and wherein the tie layer bonds with the white backer layer when subjected to heat and pressure.

13. The method of claim 9, wherein applying the protective layer includes screen printing a protective layer on a release coated carrier, and providing the digitally printed graphic image includes digitally printing a graphic image layer on top of the protective layer, and applying the adhesive layer includes screen printing a heat activated adhesive over the digitally printed graphic image layer.

14. The method of claim 13, further including screen printing a white hacker layer on top of the digitally printed graphic image layer, wherein the hybrid heat transfer label has a four-layer configuration including the protective layer/the graphic image layer/the white backer layer/the adhesive layer on the release coated carrier with the protective layer being adjacent the release coated carrier.

15. A hybrid heat transfer label, comprising:
a protective layer;
a graphic layer and
an adhesive layer,
wherein the graphic layer is digitally printed and arranged between the protective layer and the adhesive layer.

16. The hybrid heat transfer label of claim 15, wherein the protective layer and the adhesive layer are printed via a screen, flexographic, rotogravure, or pad printing method.

17. The hybrid beat transfer label of claim 15, wherein the protective layer is clear lacquer layer screen printed on a carrier, and the graphic layer is digitally printed layer on top of the protective layer, and the adhesive layer is as heat activated adhesive screen printed over the graphic layer, wherein the hybrid heat transfer label has a three-layer configuration including the protective layer/the graphic layer/the adhesive layer on the carrier with the protective layer being adjacent the carrier.

18. The hybrid heat transfer label of claim 17, further including a white backer layer, which is digitally printed or screen printed on top of the graphic layer, wherein the hybrid heat transfer label has a four-layer configuration including the protective layer/the graphic layer/white backer layer/adhesive layer on the carrier with the protective layer being adjacent the carrier.

19. The hybrid heat transfer label of claim 15, further including a second graphic layer, wherein the second graphic layer is printed via a screen, flexographic rotogravure, or pad printing method.
